(19) United States
(12) Patent Application Publication
(10) Pub. No.: US 2009/0144558 A1
(43) Pub. Date: Jun. 4, 2009

(54) Method For Anit-Keylogger

(76) Inventor: CHI-PEI WANG, Hsinchu (TW)

Correspondence Address: CHI-PEI WANG, NO. 56, XIANGBIN 1ST, SHIANGSHAN DISTRICT, HSINCHU CITY, 300, TW

(21) Appl. No.: 12/196,298

(22) Filed: Aug. 22, 2008

(30) Foreign Application Priority Data
Nov. 30, 2007 (TW) 096145506
Nov. 30, 2007 (TW) 096145507
Dec. 8, 2007 (TW) 096143363

(51) Int. Cl. H04L 9/00

(52) U.S. Cl. 713/189

(57) ABSTRACT

A method for preventing keyloggers from logging text data, that is outputted by a computer user data input device. By encrypting the text data of the user data input device, the keyloggers cannot understand the text data of the user data input device in a computer.

### FIELD OF THE INVENTION

This invention relates to user data input device, e.g. keyboard, of a computer, and particularly relates to information security in computer network.

### BACKGROUND OF THE INVENTION

Personal Computer (PC) systems utilize an open input/output (I/O) system and open Operating System (OS), so that it is possible to write spy software, spywares, Trojan horses or keyloggers to do something not being aware by users in PC. The keyloggers can log all the data from keyboards without being aware by users. The anti-spywares use the signature recognition technique to detect the keyloggers. The keyloggers can only be detectable after the spywares were found by the anti-spyware company. This kind of protection is passive. The maker of the keyloggers can easily change the signature to avoid being detected by anti-spywares, so that the keyloggers always threaten the users of PC, especially the online activities are growing rapidly in these years. It is not news for online game players losing something valueable in their game accounts. There was news that someone lost money in the banks because the account and password were stolen by keyloggers hiden in the PC of the owner of the bank account.

The keylogger issue comes from the open system, both in hardware and software. The solution is to encrypt the data packet from the start site to destination site. It means to encrypt the data before it is outputted from keyboard, and decrypted the data at the destination application. Then the problem of keylogger is solved because the keylogger can only log the encrypted data of the keyboard.

### SUMMARY OF THE INVENTION

Embodiments of the present invention provide an anti-keylogger solution by encrypting and decrypting user input data between a user data input device (e.g. keyboard) and the destination application. If the keystroke is a control key on the keyborad, the data of the control keystroke will not be encrypted. If the keystroke is a text key, the data of the text keystroke will be encrypted before software (drivers or applications) can reach it. The encryption mechanism of the present invention secures the text data, but does not disturb the control data. The encrypted text data will be decrypted at destination application.

Disclosed is a keyboard device, including a PS2 or USB port to connect to host computer, a keyboard martix to scan users' keystrokes, and a PS2 or USB protocol generator to generate related keystrokes data to host. By the protocol generator, the data of keystrokes will be encrypted in the keyboard device before sending to host computer if the keystrokes are text, for example, A, B, C, . . . Z, 0, 1, 2, . . . 9, etc.

Also disclosed is a keyboard bridge device, including a PS2 or USB port to connect to host computer, another PS2 or USB port to connect to a keyboard device, and an protocol analyzer and generator to examine the data during the traffic of a PS2 or USB transaction. The data of keystrokes will be encrypted in the keyboard bridge device before forwarding to host computer if the keystrokes are text, for example, A, B, C, . . . Z, 0, 1, 2, . . . 9, etc.

Further disclosed is a Keyboard Host Controller (KBC), including a PS2 port to connect to a PS2 keyboard, a Low Pin Count (LPC) interface to interconnect to South-bridge chip on a motherboard in a PC, and a PS2 protocol analyzer to decode and encode the data between KBC and Keyboard. By the PS2 protocol analyzer, the data of keystrokes will be encrypted in the KBC device on the motherboard if the keystrokes are text, for example, A, B, C, . . . Z, 0, 1, 2, . . . 9, etc.

Also disclosed is a computer system, including a user data input device with text encryption function, and an destination application requesting the user input data. The user data input device encrypts user input text, but does not encrypt the control data for destination application. For example, A, B, C, . . . Z, 0, 1, 2, . . . 9 are text, and Ctrl, Shift, Alt, F1, F2, . . . are controls on a keyboard. The destination application can decrypt the encrypted text.

Further disclosed is a computer network system, including a user data input device with text encryption function, an destination application requesting the user input data in local, and a remote server for decrypting the encrypted user input data. The user data input device encrypts user input text, but does not encrypt the control data for application in local. For example, A, B, C, . . . Z, 0, 1, 2, . . . 9 are text, and Ctrl, Shift, Alt, F1, F2, . . . are controls on a keyboard. The destination application in local can't decrypt the encrypted text, but the server in remote can decrypt it.

Also disclosed is another computer network system, including a user data input device with text encryption function, an destination application requesting the user input data in local, a remote server for decrypting the encrypted user input data, and another remote server requesting the user input data related to destination application. The user data input device encrypts user input text, but does not encrypt the controls in local. For example, A, B, C, . . . Z, 0, 1, 2, . . . 9 are text, and Ctrl, Shift, Alt, F1, F2, . . . are controls on a keyboard. The destination application in local can't decrypt the text, but the remote server for decrypting the text can decrypt it. Then, the decrypt text are routed to the server requesting it in remote.

Advantages of embodiments of the present invention include securing the text data from user input device for destination application, and remaining the controls unchanged for Operation System (OS) and destination application. The security is higher, and the compatibility is remained. If all the keys, including text and control data, are encrypted, the encrypted keys should be decrypted in a driver in the OS. It will cause the failure condition of security. By the present invention, it is possible and easier to secure users' keystrokes in a present computer system, without major change of the hardware and software architecture of computers.

### BRIEF DESCRIPTION OF THE DRAWINGS

Embodiments of the present invention will be more clearly understood from consideration of the following descriptions in connection with accompanying drawings in which:

FIG. 1 illustrates a PC system hardware and software with keyboard;

FIG. 2 illustrates a keyboard device functional block diagram;

FIG. 3 illustrates a PC system with keyboard bridge adapter;

FIG. 4 illustrates a keyboard bridge adapter functional block diagram;

FIG. 5 illustrates a KBC functional block diagram on the motherboard;

FIG. 6 illustrates a computer network system for anti-keylogger;

FIG. 7 illustrates the network system flow chart for anti-keylogger; and

FIG. 8 illustrates a look of the anti-keylogger application client.

Corresponding numerals and symbols in the different figures refer to corresponding parts unless otherwise indicated. The figures are drawn to clearly illustrate the relevant aspects of the preferred embodiments and are not necessarily drawn to scale.

### DETAIL DESCRIPTION OF THE PREFERRED EMBODIMENT

A description of a prior art PC system with user data input will be described, followed by a description of some preferred embodiments of the present invention, and a discussion of some advantages thereof.

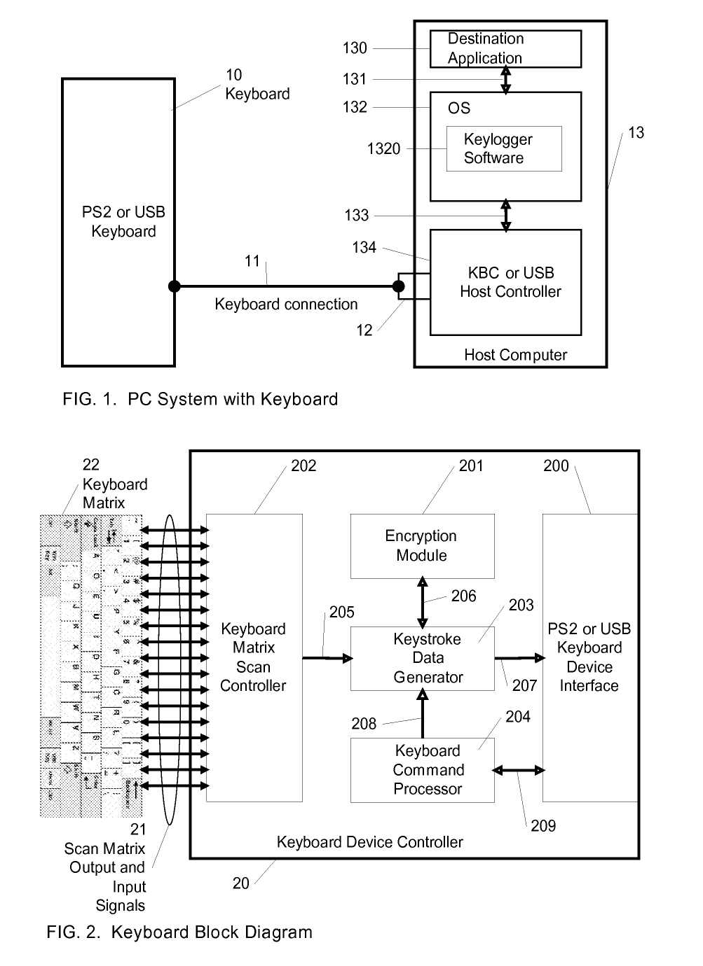

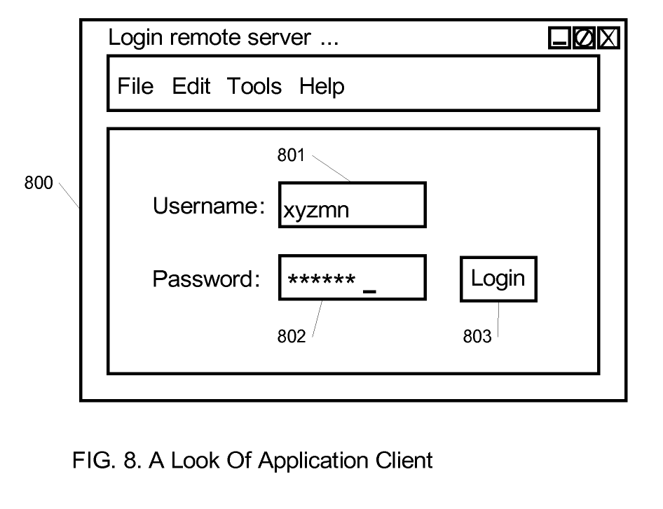

FIG. 1 is a computer system with software and hardware of keyboard. Users stroke a key on the keyboard 10, the keystroke will be outputted through the keyboard connection 11. The keyboard connection 11 could be PS2 or USB connector 12 nowadays to connect to host computer 13. The keystroke data is received by KBC or USB host controller 134, depending on the keyboard 10 and keyboard connection 11 is PS2 or USB type in host computer 13. The Operation System (OS) 132 and keylogger software 1320 can get the keystroke data by KBC or USB host controller 134. Generally, the keylogger 1320 spies on some layer of OS, so that it is a part inside the OS 132. Destination application 130 can't know whether there is a keylogger 1320 inside the OS 132 or not. FIG.8 is a look of destination application 130 to login a computer server system. The main target of this invention is to secure the text in the text boxes of username 801 and password 802 in FIG. 8.

Embodiments of the present invention is to protect the keystrokes data from being stoken by the keylogger 1320. The method is to encrypt the keystrokes data before the hardware programming interface 133, then decrypt the keystrokes data after the software programming interface 131. In the present embodiments, the keystrokes data is decrypted at the destination application text box 801 and 802 in FIG. 8, or the remote decryption server 63 in FIG.6 that will be descripted in the following paragraphs.

FIG. 2 keyboard device controller is one of the embodiments of the present invention related keyboard 10 in FIG. 1. The keystrokes data is encrypted in the keyboard 10. FIG. 2 shows the block diagram of the keyboard device controller with encryption function. Keyboard device interface (PS2 or USB) 200 connects to keyboard connection 11 in FIG. 1. By the interface specifications, the keyboard device interface processes the PS2 or USB protocols of keyboard. The protocols of keyboard including keyboard commands and keystroke data. The PS2 keyboard command is issued by writing a byte data to IO port 60h by KBC 134 in host computer 13, then following by arguments as the Table 1. For example, the Reset command will start by write IO port 60h with data FFh, then the keyboard device 10 will return a FAh to KBC host controller 134 for device acknowledging, follows a AAh after the keyboard is reseted.

TABLE 1
PS2 Keyboard Commands

| Code | command | Description and Command Format |
|---|---|---|
| FFh | Reset | Resets Keyboard device. Keyboard device will return |
| | | 0xFA, follows a 0xAA after reseted. |
| | | Format: FF FA AA |
| FEh | Resend | Keyboard responses the last byte sent to host. |
| | | Generally, the command is used to indicate an error |
| | | condition(parity error) found by software. |
| | | Format: FE FA RR (RR is the last byte sent to host) |
| F6h | Set | Sets keyboard typematic rate/delay to be default |
| | Default | (10.9 cps/500 ms), and scan code set (2). |
| | | Format: F6 FA |
| F5h | Disable | Stops keyboard, and set default as “Set Default” |
| | | command) |
| | | Format: F5 FA |
| F4h | Enable | Enables keyboard after Disable command. |
| | | Format: F4 FA |
| F3h | Set | Sets the keyboard typematic rate and delay by a |
| | Typematic | argument byte. |
| | Rate/ | Format: F3 FA WW FA (WW is the argument byte |
| | Delay | writted from IO port 0x60). |
| F2h | Get | The keyboard responds a two-byte device ID AB 41. |
| | Device ID | Format: F2 FA AB 41 |
| F0h | Set Scan | Sets the Scan Code Set of keyboard device. The |
| | Set Code | argument byte could be 0x01, 0x02, or 0x03 to select |
| | | the Scan Code Set 1, 2, or 3, respectively. The |
| | | argument 0 means to get the current Scan Code Set. |
| | | Format 1: F0 FA WW FA (WW is not zero) |
| | | Format 2: F0 FA 00 FA RR (RR is the returned current |
| | | Scan Code Set). |
| EEh | Echo | The keyboard responds 0xEE. |
| | | Format: EE EE |
| Edh | Set LEDs | Set the LEDs status of the keyboard, including Num |
| | | Lock, Caps Lock, Scroll Lock. |
| | | Format: ED FA WW FA |
| | | Bit0~2 of WW is the value to set LEDs status |
| | | Bit 0: Scroll Lock LED off(0)/on(1) |
| | | Bit 1: Num Lock LED off(0)/on(1) |
| | | Bit 2: Caps Lock LED off(0)/on(1) |

The protocols of commands in keyboard 10 are controlled by keyboard command processor 204 in keyboard device controller 20. Keyboard device interface 200 manages the BUS interface to be PS2 or USB, and connects to KBC or USB host controller by keyboard connection 11. The keyboard command processor 204 interacts with keyboard device interface 200 through internal signals or programming interface 209.

The keystroke data of keyboard 10 is generated by keystroke data generator 203 in keyboard device controller 20 when the keyboard matrix scan controller 202 scanned one or more keystroke events are pressed or released. The keystroke data is encrypted by encryption module 201 if the pressed or released key is a text. The encrypted keystroke data is then sent to host through the interface 207 to keyboard device interface 200.

The embodiment of the present invention is achieved by the special function in keystroke data generator 203. The function separates the keys into text and control keys. If the key is text, number or symbol, for example: A, B, C, . . . Z, 0, 1, 2, . . . 9, the keystroke data will be encrypted. On the other hand, the Ctrl, Shift, Alt, F1, F2 . . . keys will not be encrypted.

The keystroke data protocol between KBC host controller 134 and keyboard is done by keystroke data generator 203 and keyboard device interface 200. The keystroke data generator 203 manages the BUS independent data protocol. But the keyboard device interface 200 manage the data according to the interface 200 is PS2 or USB BUS interface. For example, the PS2 keystroke data seperated to “make” key and “break” key. The make key means the user pressed a key. And the break key means the user released a key. The PS2 protocol defines the make keys and break keys as fellows,

TABLE 2
PS2 Key Format (Set2 Scan Code)

| Make | Break | Key Descriptions |
|---|---|---|
| 01 | F0 01 | F9 |
| 03 | F0 03 | F5 |
| 04 | F0 04 | F3 |
| 05 | F0 05 | F1 |
| 06 | F0 06 | F2 |
| 07 | F0 07 | F12 |
| 08 | F0 08 | F13 |
| 09 | F0 09 | F10 |
| 0a | F0 0a | F8 |
| 0b | F0 0b | F6 |
| 0c | F0 0c | F4 |
| 0d | F0 0d | Tab |
| 0e | F0 0e | \grave{ } ~ |
| 0f | F0 0f | Keypad = |
| 10 | F0 10 | F14 |
| 11 | F0 11 | Left Alt |
| 12 | F0 12 | Left Shift |
| 13 | F0 13 | Keyboard Intl'2 (Katakana/Hiragana) |
| 14 | F0 14 | Left Control |
| 15 | F0 15 | q Q |
| 16 | F0 16 | 1 ! |
| 18 | F0 18 | F15 |
| 1a | F0 1a | z Z |
| 1b | F0 1b | s S |
| 1c | F0 1c | a A |
| 1d | F0 1d | w W |
| 1e | F0 1e | 2 @ |
| 20 | F0 20 | F16 |
| 21 | F0 21 | c C |
| 22 | F0 22 | x X |
| 23 | F0 23 | d D |
| 24 | F0 24 | e E |
| 25 | F0 25 | 4 $ |
| 26 | F0 26 | 3 # |
| 27 | F0 27 | Keyboard Int'l 6 (PC9800 Keypad , ) |
| 28 | F0 28 | F17 |
| 29 | F0 29 | Space |
| 2a | F0 2a | v V |
| 2b | F0 2b | f F |
| 2c | F0 2c | t T |
| 2d | F0 2d | r R |
| 2e | F0 2e | 5 % |
| 30 | F0 30 | F18 |
| 31 | F0 31 | n N |
| 32 | F0 32 | b B |
| 33 | F0 33 | h H |
| 34 | F0 34 | g G |
| 35 | F0 35 | y Y |
| 36 | F0 36 | 6 \hat{ } |
| 38 | F0 38 | F19 |
| 3a | F0 3a | m M |
| 3b | F0 3b | j J |
| 3c | F0 3c | u U |
| 3d | F0 3d | 7 & |
| 3e | F0 3e | 8 * |
| 40 | F0 40 | F20 |
| 41 | F0 41 | , < |
| 42 | F0 42 | k K |
| 43 | F0 43 | i I |
| 44 | F0 44 | o O |
| 45 | F0 45 | 0 ) |
| 46 | F0 46 | 9 ( |
| 48 | F0 48 | F21 |
| 49 | F0 49 | . > |
| 4a | F0 4a | / ? |
| 4b | F0 4b | l L |
| 4c | F0 4c | ; : |
| 4d | F0 4d | p P |
| 4e | F0 4e | - _{—} |
| 50 | F0 50 | F22 |
| 51 | F0 51 | Keyboard Int'l 1 (Ro) |
| 52 | F0 52 | ‘ “ ;” |
| 54 | F0 54 | [ { |
| 55 | F0 55 | = + |
| 57 | F0 57 | F23 |
| 58 | F0 58 | Caps Lock |
| 59 | F0 59 | Right Shift |
| 5a | F0 5a | Return |
| 5b | F0 5b | ] } |
| 5d | F0 5d | \ \| |
| 5f | F0 5f | F24, Keyboard Lang S (Zenkaku/Hankaku) |
| 61 | F0 61 | Europe 2 |
| 62 | F0 62 | Keyboard Lang 4 (Hiragana) |
| 63 | F0 63 | Keyboard Lang 3 (Katakana) |
| 64 | F0 64 | Keyboard Int'l 4(Henkan) |
| 66 | F0 66 | Backspace |
| 67 | F0 67 | Keyboard Int'l 5(Muhenkan) |
| 69 | F0 69 | Keypad 1 End |
| 6a | F0 6a | Keyboard Int'l 2(Yen) |
| 6b | F0 6b | Keypad 4 Left |
| 6c | F0 6c | Keypad 7 Home |
| 6d | F0 6d | Brazilian Keypad . |
| 70 | F0 70 | Keypad 0 Insert |
| 71 | F0 71 | Keypad . Delete |
| 72 | F0 72 | Keypad 2 Down |
| 73 | F0 73 | Keypad 5 |
| 74 | F0 74 | Keypad 6 Right |
| 75 | F0 75 | Keypad 8 Up |
| 76 | F0 76 | Escape |
| 77 | F0 77 | Num Lock |
| 78 | F0 78 | F11 |
| 79 | F0 79 | Keypad + |
| 7a | F0 7a | Keypad 3 PageDn |
| 7b | F0 7b | Keypad − |
| 7c | F0 7c | Keypad * |
| 7d | F0 7d | Keypad 9 PageUp |
| 7e | F0 7e | Scroll Lock |
| E0 10 | E0 F0 10 | WWW Search |
| E0 11 | E0 F0 11 | Right Alt |
| E0 12 | E0 F0 12 | Print Screen 1 |
| E0 14 | E0 F0 14 | Right Control |
| E0 15 | E0 F0 15 | Scan Previous Track |
| E0 18 | E0 F0 18 | WWW Favorites |
| E0 1F | E0 F0 1F | Left GUI |
| E0 20 | E0 F0 20 | WWW Refresh |
| E0 21 | E0 F0 21 | Volume Down |
| E0 23 | E0 F0 23 | Mute |
| E0 27 | E0 F0 27 | Right GUI |
| E0 28 | E0 F0 28 | WWW Stop |
| E0 2B | E0 F0 2B | Calculator |
| E0 2F | E0 F0 2F | App |
| E0 30 | E0 F0 30 | WWW Forward |
| E0 32 | E0 F0 32 | Volume Up |
| E0 34 | E0 F0 34 | Play/Pause |
| E0 37 | E0 F0 37 | System Power, Keyboard Power |
| E0 38 | E0 F0 38 | WWW Back |
| E0 3A | E0 F0 3A | WWW Home |
| E0 3B | E0 F0 3B | Stop |
| E0 3F | E0 F0 3F | System Sleep |
| E0 40 | E0 F0 40 | My Computer |
| E0 48 | E0 F0 48 | Mail |
| E0 4A | E0 F0 4A | Keypad/ |
| E0 4D | E0 F0 4D | Scan Next Track |
| E0 50 | E0 F0 50 | Media Select |
| E0 5A | E0 F0 5A | Keypad Enter |
| E0 5E | E0 F0 5E | System Wake |
| E0 69 | E0 F0 69 | End |
| E0 6B | E0 F0 6B | Left Arrow |
| E0 6C | E0 F0 6C | Home |
| E0 70 | E0 F0 70 | Insert |
| E0 71 | E0 F0 71 | Delete |
| E0 72 | E0 F0 72 | Down Arrow |
| E0 74 | E0 F0 74 | Right Arrow |
| E0 75 | E0 F0 75 | Up Arrow |
| E0 7A | E0 F0 7A | Page Down |
| E0 7C | E0 F0 7C | Print Screen 2 |
| E0 7D | E0 F0 7D | Page Up |
| E0 7E | E0 F0 7E | Ctrl-Break |

(all Make and Break code are hexadecimal.)

By the Table 2, the make key and break key are different in leading a F0. Thus the keystroke data generator 203 can separate the make and break keys, and encrypts them by the same mapping table (A Translate Table for encryption), but doesn't encrypt the leader F0. Furthermore, the keystroke data generator 203 can encrypt the selected only text keys, but doesn't encrypts control keys. The reason of encrypting the selected only text key is to reduce the compatibility issue of destination application 130 and OS 132 in FIG. 1. The controls of the application remains unchanged, but the text is encrypted. Thus the anti-keylogger with software compatibility can be achieved. If the control keys are encrypted, the keys should be decrypted in OS, thus all the keys, not only control keys but also text keys, may be logged by keylogger 1320. Then the ability of anti-keylogger is gone. Embodiments of the present invention remain the control keys to be the same as a normal keyboard. The control keys functions of destination application 130 and OS 132 are not affected. But the text keys are encrypted by encryption module 201 in FIG. 2.

The control signals or programming interface 208 is used for enabling, disabling and changing the parameters of encryption. For example, in the embodiments of the present invention, there are some extended PS2 commands for setting the encryption module 201:

TABLE 3
PS2 Keyboard Extended Commands For Encryption

| Code | command | Description and Command Format |
|---|---|---|
| 30h | Set Translate Off | Turn off the encryption. |
| | | Format: 30 FA |
| 31h | Set Translate On | Turn on the encryption. |
| | | Format: 31 FA |
| 32h | Get Translate ID | Translate ID is one of the parameterr for the encryption |
| | | module. The Translate ID may be changed for several |
| | | times. For example, the server may request destination |
| | | to change Translate ID whenever there is a “Enter” key |
| | | coming. |
| | | Format: 32 FA AA BB CC DD EE FF GG HH |
| | | AA, BB . . . HH are Translate ID (TID) in 8 bytes |
| | | sequence. |
| | | AA is LSB, HH is MSB. |
| 33h | Get Device Serial ID | Device Serial ID is one of the parameter for the |
| | | encryption module. The Device Serial ID is fixed when |
| | | the keyboard is made. |
| | | Format: 33 FA AA BB CC DD EE FF GG HH |
| | | AA, BB . . . HH are Device Serial ID (SID) in 8 bytes |
| | | sequence. AA is LSB, HH is MSB. |
| 34h | Get Translate Table | The Translate Table(TT) is used for host computer to |
| | | remap the text key. This table is encrypted by some |
| | | means known by both side (keyboard 10 and |
| | | destination application 130 or remote server 63) for |
| | | security. |
| | | Format: 34 FA . . . (following 64 bytes), (encrypted data |
| | | by sequence byte 0, 1, 2, 3, . . . 63 = TT) |

There is also another implementation to achieve the same goal of setting parameters of encryption module 201 without use the new added PS2 commands. For example, to use the Scroll Lock function on keyboard 10 as the enable or disable of encryption function 201 of keyboard device 20. When the Scroll Lock LED is on, it means the encryption module 201 is enabled. When the Scroll Lock LED is off, it means the encryption module 201 is disabled. The Scroll LED is set by ED (Set LED) command of PS2 in Table 1. When the Scroll LED is set, the keystroke data generator 203 sends a serial of make keys and break keys. The make and break keys are formed by the Translate ID, Device Serial ID and Translate Table in hexadecimal ASCII. For example, hexdecimal AB, the keystroke data generator 203 sends make and break key A, following make and break key B. Only A, B, . . . Z, 0, 1, . . . 9 Scan Code are used for sending the Translate ID, Device Serial ID and Translate Table to destination application 130 or remote server 63. The implementation reduce the new PS2 commands compatibility issue. The Translate ID, Device Serial ID and Translate Table are all sent by simulated keystrokes data.

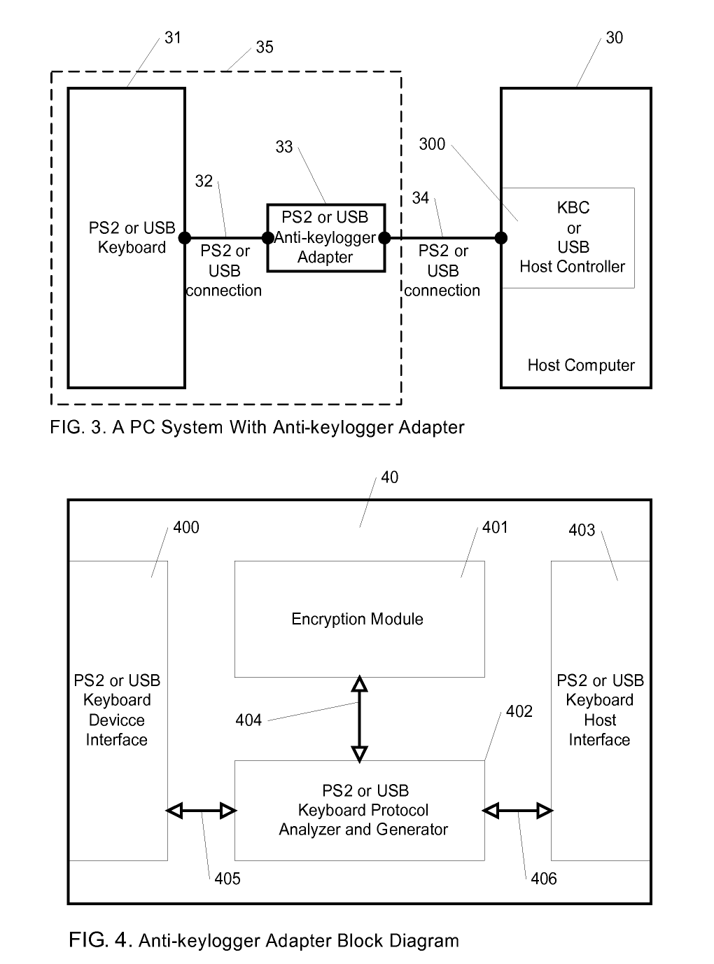

FIG. 3 is another embodiment for the present invention. The keyboard connection 11 in FIG. 1 is replace by connection 32 and 34, and anti-keylogger adapter 33. The keyboard 31 is a normal keyboard without anti-keylogger function. But the keyboard adapter 33 is an adapter to enhance the normal keyboard to be an anti-keylogger keyboard 35 as keyboard 10 in FIG. 1. The combination of the keyboard 31, connection 32 and adapter 33 can achieve the same function as keyboard 10 in FIG. 1. The connection 34 acts as the same role as keyboard connection 11 in FIG. 1.

FIG. 4 shows the block diagram of anti-keylogger adapter 40. The anti-keylogger adapter 40 in FIG.4 is relative to anti-keylogger adapter 33 in FIG. 3. The function of keyboard device interface 400 and keyboard host interface 403 manage the PS2 or USB BUS protocols. The encryption module 401 does the same function as encryption module 201 in FIG. 2. The protocol analyzer and generator 402 is a bridge to manage the data flow between keyboard device interface 400 and keyboard host interface 403. The protocol analyzer and generator 402 gets the parameters for encryption module 401 from keyboard host interface 403, but does not forward to keyboard device interface 400. In other words, the protocol analyzer and generator 402 is not going to forward the new PS2 commands in Table 3 to keyboard device interface 400 of the PS2 adapter 40. On the other hand, the protocol analyzer and generator 402 gets the text keystrokes from keyboard device interface 400 and forwards to keyboard host interface 403. Additionally, if the the encryption mode is enabled, the data of text keystrokes will be encrypted by encryption module 401.

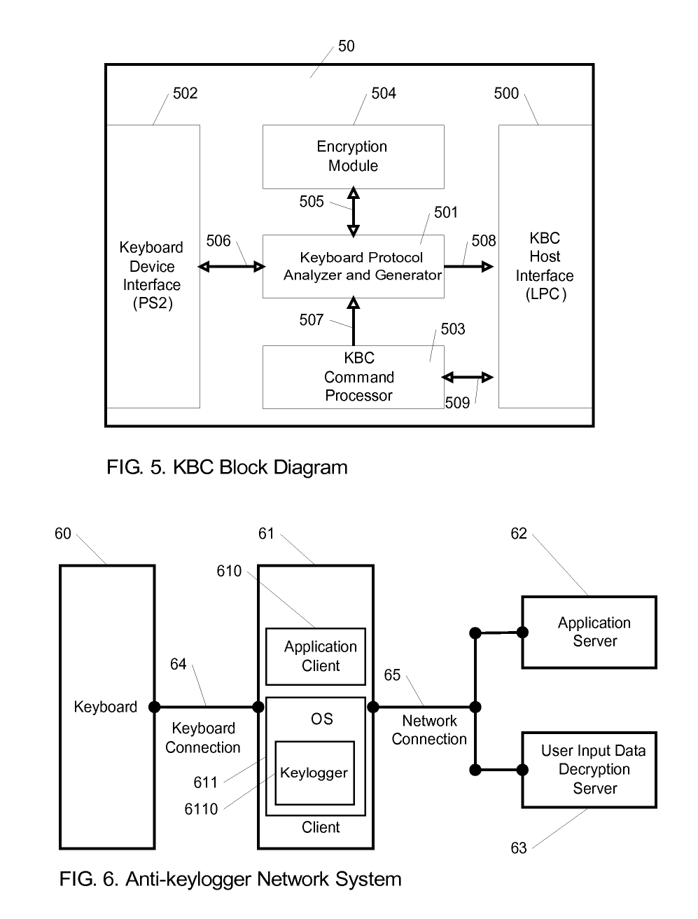

FIG. 5 is also another kind of embodiment for the present invention. The block diagram relates to KBC host controller 134 in FIG. 1. But the encryption module 504 is located in KBC 50 in the embodiment of the present invention. In this case, the keyboard 10 and keyboard connection 11 in FIG. 1 remain to be unchanged. The KBC host controller 134 in FIG. 1 performs the encryption function. FIG. 5 is the detail drawing of KBC host controller 134. Generally, the KBC 50 is coupled to PC motherboard by LPC host interface 500. There are two IO ports: 60h and 64h in KBC hardware programming interface 133 for software to communicate with KBC 50. The hardware programming interface 133 in FIG. 1 is the protocols of IO 60h and 64h for software to communicate with KBC host controller 134. The IO port 60h and 64h, and KBC 50 commands (write IO 64h) are defined as fellows,

TABLE 4
KBC Host Controller Interface (IO 60h And 64h) Description

| Port | Name | Description and Command Format |
|---|---|---|
| Read 60h | KBC | Read KBC data ouput buffer. |
| | Data | If there is no command issued, the data may come |
| | Output | from keyboard device or mouse device, depending |
| | | on the status of 64h(KBC Status) bit 0 and 5 OBF. |
| | | If the data is coming from keyboard device, the |
| | | format maybe Set 1 or Set 2 Scan Code depending |
| | | on Bit6 Scan Code Conversion of command byte |
| | | setting of KBC command 60h in Table 5. |
| Write 60h | KBC | Write KBC data input buffer. |
| | Data | If there is no KBC command before write IO 60h. |
| | Input | The write IO 60h is a keyboard device command |
| | | for the PS2 keyboard device. The PS2 keyboard |
| | | commands are list in Table 1 and 3. For PS2 mouse |
| | | command, the KBC command D4h should be isuued |
| | | before write IO 60h to mouse device. |
| Write 64h | KBC | issue a KBC command to KBC host controller. |
| | Com- | |
| | mand | |
| Read 64h | KBC | Read KBC status. |
| | Status | Bit0: OBF, Output Buffer Full flag. |
| | | Bit1: IBF, Input Buffer Full flag. |
| | | Bit2: System Flag, indicates the system POST is |
| | | finished. |
| | | Bit3: A2, Address bit for last write IO 60h(0) or |
| | | 64h(1). |
| | | Bit4: Uninhibited, indicates keyboard is inhibited. |
| | | Bit5: AUX OBF, for PS2 mouse data output flag. |
| | | Bit6: General Time-out, indicates PS2 BUS |
| | | time-out condition. |
| | | Bit7: Parity Error, indicates PS2 BUS parity error |
| | | condition. |

TABLE 5
KBC Commans.

| Code | command | Description and Command Format |
|---|---|---|
| 20h | Read Command Byte | Read command byte of KBC. Command byte is a |
| | | location in KBC, as fellows, |
| | | Bit0: IRQ1 enable |
| | | Bit1: IRQ12 enable |
| | | Bit2: System flag |
| | | Bit3: Inhibit override |
| | | Bit4: Keyboard device disable |
| | | Bit5: mouse device disable |
| | | Bit6: Scan Code Conversion |
| | | 1: KBC will convert Set 2 to Set 1 Scan Code |
| | | 0: KBC will not convert Set2 to Set 1 Scan Code |
| | | Bit7: N.A. |
| 60h | Write Command Byte | Write a byte to command byte of KBC to update the |
| | | KBC configuration setting as described in 20h, Read |
| | | Comamnd Byte. |
| A7h | Disable Mouse Device | |
| A8h | Enable Mouse Device | |
| A9h | Test Mouse Port | Test the mouse PS2 port of KBC. |
| Aah | Self Test | KBC perform self test and disable keyboard/ |
| | | mouse devices. |
| Abh | Test Keyboard Port | Test the keyboard PS2 port of KBC. |
| Adh | Disable Keyboard Devcie | |
| Aeh | Enable Keyboard Device | |
| C0h | Read Port1 | Read the Port 1 status of 8042. The command always |
| | | get 00h. |
| D0h | Read Port2 | Read the Port 2 status of 8042. Only bit1 is valid for |
| | | Read GA20 status. |
| D1h | Write Port2 | Only bit1 are valid for setting GA20. |
| D2h | Write KBC Keyboard Output Buffer | Write a byte to as the data is coming from keyboard |
| | | device for KBC. |
| D3h | Write KBC Mouse Output Buffer | Write a byte to as the data is coming from mouse |
| | | device for KBC. |
| D4h | Mouse Port Prefix | For write command to PS2 mouse device before write |
| | | IO port 60h. D4h is a prefixed command to separate |
| | | the |
| | | Port 60h command is for keyboard or mouse device. |
| E0h | Read Test Input | Always return 00h. |
| Feh | Keyboard Reset | Generate a low pulse KBRST# signal on KBC to reset |
| | | PC system. |

To support anti-keylogger function in KBC 50. There are some extended KBC command to perform the encryption function, just as the PS2 Keyboard Extended Commands in Table 3.

TABLE 6
KBC Extended Commands For Encryption

| Code | command | Description and Command Format |
|---|---|---|
| 30h | Set Translate Off | Turn off the encryption. |
| | | Format: 30 |
| 31h | Set Translate On | Turn on the encryption. |
| | | Format: 31 |
| 32h | Get Translate ID | Translate ID is one of the parameterr for the encryption |
| | | module. The Translate ID may be changed for several |
| | | times. For example, the server may request destination |
| | | to change Translate ID whenever there is a “Enter” key |
| | | coming. |
| | | Format: 32 AA BB CC DD EE FF GG HH |
| | | AA, BB . . . HH are Translate ID (TID) in 8 bytes |
| | | sequence. |
| | | AA is LSB, HH is MSB. |
| 33h | Get Device Serial ID | Device Serial ID is one of the parameterr for the |
| | | encryption module. The Device Serial ID is fixed when |
| | | the keyboard is made. |
| | | Format: 33 AA BB CC DD EE FF GG HH |
| | | AA, BB . . . HH are Device Serial ID (SID) in 8 bytes |
| | | sequence. AA is LSB, HH is MSB. |
| 34h | Get Translate Table | The Translate Table(TT) is used for host computer to |
| | | remap the text key. This table is encrypted by some |
| | | means known by both side (keyboard 10 and |
| | | destination application 130 or remote server 63) for |
| | | security. |
| | | Format: 34 . . . (following 64 bytes), (encrypted data by |
| | | sequence byte 0, 1, 2, 3, . . . 63 = TT) |

In FIG. 5 KBC command processor 503 processes the command coming from KBC host interface 500. The KBC extended commands will affect the keyboard protocol analyzer and generator 501 to encrypt the data of text keystrokes from keyboard device interface 502 if the encryption mode is enabled. The data of control keystrokes will not be changed.

FIG. 6 is a network system of anti-keylogger. When the keyboard 60 outputs a keystroke data to client computer 61, the application client 610 gets the encrypted text data and sends the encrypted text data to user input data decryption server 63 to decrypt via network connection 65. After decrypted, the real keystrokes data are send to application server 62 via network connection 65. Another embodiment may let the function of the decryption server 63 in client computer 61, thus there is no decryption server in the network. Also the implemetation may let decryption server 63 as a function of application server 62. The anti-keylogger function remains the same for different implementations of the present invention. That is the keylogger 6110 will not get the real keystrokes text of users.

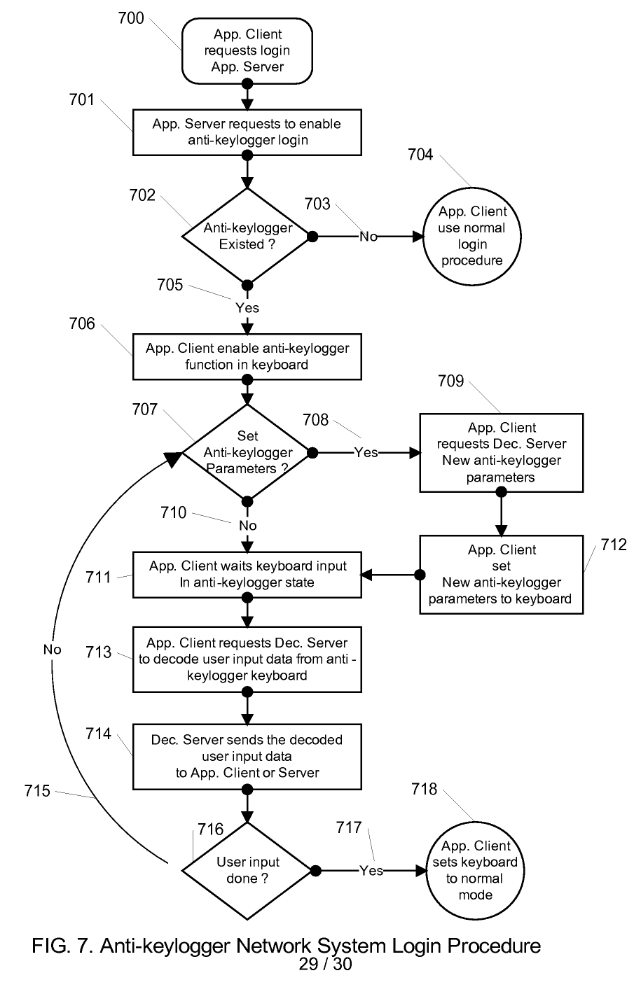

FIG. 7 is a flow chart for describing the operation in FIG. 6. FIG. 8 is an example look of application client 610 in FIG. 6. When the application client 610 or 800 is waiting for user input in username text box 801 and password text box 802, the application client 800 starts the flow (requests login app. server 700). Then the application server request to enable anti-keylogger login 701 in application client 610. If there is no anti-keylogger function existed 702 in the keyboard 60 of the client computer 61, the flow goes to normal login procedure 704 without anti-keylogger ability. If there is anti-keylogger existed 705 in the keyboard 60 of the client computer 61, the application client 610 enables the anti-keylogger function in keyboard 60 at the stage 706. The decryption server 63 may want to change the encryption parameters in keyboard 60 by flow of 707, 708, 709 and 712. If the encryption parameters don't need to be changed, the flow goes 707, 710, and waits keyboard input 711 user's data. After users inputting the data, which is encrypted, the application client 610 requests decryption server 63 to decode the user input data from anti-keylogger keyboard 713. Then, the decryption server sends decoded user input data to application client 610 or application server 62. The application client 610 may request user to input data and change the parameters by flow 715 to 707. Or the user may click the “login” 803 button in FIG. 8 to finished the anti-keylogger flow by 716, 717 and application client sets keyboard to normal mode 718.

In FIG. 8, the username text box shows “xyzmn” is the encrypted code (Let's say the real keystrokes of the user is “abcde”. The encrypted keystrokes data is “xyzmn”). If the decrypted code “abcde” is sent back to application client in 714, the application client 800 may show the real data “abcde” in username text box 801. The problem is that some keyloggers may include screen-logger ability. The screen of the user input may be captured “abcde” by the screen-logger. It's a risk for critical information, for example the credit card number. It's better to decrypt in the decryption server 63 and send the real user input data to application server 62 directly, but not show the real keystrokes data on screen. Furthermore, maybe the user can read the real text on the small LCD module on the keyboard 60. The small LCD module is attached on the keyboard 60, and always show the real keystrokes of user inputting. But In some conditions, it's impossible to show the encrypted text on screen, for example, the instant chating program, MSN Messenger and Yahoo Messenger. In this kind of case, the application client 800 can only shows the dedoded text on text box 801 for chating program.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description. In addition, the order of process steps may be rearranged by one of ordinary skill in the art, yet still be within the scope of the present invention. It is therefore intended that the appended claims encompass any such modifications or embodiments. Moreover, the scope of embodiments of the present application is not intended to be limited to the particular embodiments of the process, machine, manufacture, composition of matter, means, methods and steps described in the specification. Accordingly, the appended claims are intended to include within their scope such processes, machines, manufacture, compositions of matter, means, methods, or steps.

What is claimed is:

1. An method for providing an anti-keylogger user input data for a computing device, the method comprising:
An user data input device via which the user input text data is encrypted, but the user inputs control data is not encrypted;and
decrypting said encrypted text data at destination application.

2. The user data input device of claim 1, wherein the user data input device comprises a keyboard, keypad, touchscreen, or bar-code scanner; and outputs two categories of said user input data: text data and control data to said computing device.

3. The text data of claim 2, wherein the text data is predetermined set of letters, numbers, symbols.

3. The control data of claim 2, wherein the control data is predetermined set for application controlling purposes.

4. The destination application of claim 1, wherein the destination application is a software requesting said user input data in said computing device, or the remote server relative to said destination application requesting said user input data.

5. An anti-keylogger user data input device for computer comprising:
an input interface via which user inputs data; and
An user data generator via which user input said text data is encrypted, and said control data is not encrypted; and
A output interface via which said encrypted text and said control data are sent to said computer;

6. The user data input device of claim 5, wherein the user data input device comprises a keyboard, keypad, touchscreen, or bar-code scanner.

7. The input interface of claim 5, wherein the input interface is a matrix of input and output signals of a said keyboard, keypad, touchscreen, or light sensors in said bar-code scanner.

8. The output interface of claim 5, wherein the output interface comprises PS2 or USB BUS for connecting to said computer.

9. An anti-keylogger bridge device for computer comprising:
An input interface connecting to said user data input device, via said input interface, plain said user input text and control data is received from said user input device;
An user data analyzer and generator via which plain said text data is encrypted, and plain said control data is not encrypted; and
A said output interface via which said encrypted text and plain control data are sent to said computer;

10. The input interface of claim 9, wherein the input interface comprises said PS2 or USB BUS for connecting to said PS2 or USB keyboard device.

11. The user input device of claim 9, wherein the user input device is a PS2 or USB keyboard, keypad, touchscreen, or bar-code scanner.

12. The user input plain text and control data of claim 9, wherein the plain text and control data are data not encrypted by said user input device.

13. The user data analyzer and generator of claim 9, wherein the user data analyzer and generator analyze and generate said PS2 or USB user input device protocols between said input interface and said output interface.

14. The PS2 or USB user input device protocols of claim 13, wherein the PS2 or USB user input device is PS2 or USB keyboard or keypad device.

15. The output interface of claim 9, wherein the output interface comprises PS2 or USB BUS for connecting to said computer, or LPC BUS for coupling to the south-bridge on a motherboard in said computer.

16. An anti-keylogger computer system comprising:
An said anti-keylogger input device via which said user inputs text data is encrypted, and said control data is not encrypted; and
A said destination application decrypts the said encrypted text data;

17. An anti-keylogger computer network system comprising:
An said anti-keylogger input device via which said user inputs text data is encrypted, and said control data is not encrypted; and
A said destination application requesting said anti-keylogger user data input, via said destination application said encrypted text data is sent to a network server via network connection;
A server via which said encrypted text data from said destination application is decrypted.
A network connects said destination application and said server.
